(19) United States
(12) Patent Application Publication
(10) Pub. No.: US 2013/0155117 A1
(43) Pub. Date: Jun. 20, 2013

(54) DISPLAY APPARATUS AND METHOD AND COMPUTER-READABLE STORAGE MEDIUM

(71) Applicant: Hyo-sang Bang, Seoul (KR)

(72) Inventor: Hyo-sang Bang, Seoul (KR)

(73) Assignee: Samsung Electronics Co., Ltd., Suwon-si (KR)

(21) Appl. No.: 13/592,695

(22) Filed: Aug. 23, 2012

(30) Foreign Application Priority Data
Dec. 16, 2011 (KR) 10-2011-0136560

(51) Int. Cl. G09G 5/373

(52) U.S. Cl. 345/668

(57) ABSTRACT

A display apparatus and method allow automatic partitioning of a display screen according to the number of content items so as to minimize a page scroll according to the number of captured content items when the content is reproduced, to increase user convenience, and a computer-readable recording medium having stored thereon computer program codes for executing the display method. The display apparatus includes a display controller that allows first content and second content to be displayed on a first area and a second area of a display screen, respectively. The display controller divides the first and second areas according to a golden ratio.

### CROSS-REFERENCE TO RELATED PATENT APPLICATION

This application claims the priority benefit of Korean Patent Application No. 10-2011-0136560, filed on Dec. 16, 2011, in the Korean Intellectual Property Office, the disclosure of which is incorporated herein in its entirety by reference.

### BACKGROUND

Various embodiments relate to a display apparatus and method and a computer-readable storage medium having stored thereon computer program codes for executing the display method.

In general, digital photographing apparatuses such as digital cameras and camcorders display images or moving pictures stored in a recording medium in a display mode. In most cases, the captured images and moving pictures are correlated with each other.

For example, moving images and still images may be captured simultaneously in a dual photographing mode or dual recording mode, but cannot be displayed at the same time. Thus, a user may be inconvenienced in having to separately view the still and moving images.

In particular, still images are displayed in one of a selected full view mode or thumbnail view mode. A page scroll occurs more frequently as the number of the images increases.

### SUMMARY

Various embodiments provide a display apparatus and method adapted to minimize a page scroll according to the number of captured content when the content is reproduced by automatically partitioning a display screen according to the number of content items, and a computer-readable recording medium having stored thereon computer program codes for executing the display method.

According to an embodiment, there is provided a display apparatus including a display controller that allows first content and second content to be displayed on a first area and a second area of a display screen, respectively. The display controller divides the first and second areas according to a golden ratio.

The display controller may partition the second area according to the number of the second content items according to the golden ratio. The second content may be displayed in the form of slides. The display controller may also adjust the number of partitions in the second area. When the number of the second content items exceeds a predetermined number, the display controller may update the second area with the second content other than the predetermined number of the second content items for display. The display controller may divide the first and second areas at the golden ratio derived from the Fibonacci sequence. The first content may be moving image data, and the second content may be still image data. The still image data may constitute the moving image data.

In another embodiment, the display apparatus includes a display controller that allows first content and second content to be displayed on a first area and a second area of a display screen, respectively, and a synchronizing unit that changes the display of the second content being displayed according to a time point at which the first content is displayed. The display controller divides the first and second areas of the display screen according to a golden ratio.

The display controller may partition the second area according to the number of the second content items at the golden ratio. The second content may be displayed in the form of slides. The display controller may also adjust the number of partitions in the second area. When the number of the second content items exceeds a predetermined number, the display controller may update the second area with the second content other than the predetermined number of the second content items for display. The display controller may divide the first and second areas at the golden ratio derived from the Fibonacci sequence. The first content may be moving image data, and the second content may be still image data. The still image data may constitute the moving image data.

According to another aspect embodiment, there is provided a display method including: dividing a display screen according to a golden ratio and displaying first content and second content on a first area and a second area of the display screen, respectively.

In another embodiment, the display method includes dividing a display screen according to a golden ratio; displaying first content and second content on a first area and a second area of the display screen, respectively; and changing the display of the second content according to a time point at which the first content is displayed.

According to another embodiment, there is provided a computer-readable storage medium having stored thereon computer program codes executable by a processor for implementing a display method, the display method including dividing a display screen according to a golden ratio and displaying first content and second content on a first area and a second area of the display screen, respectively.

In another embodiment, a computer-readable storage medium has stored thereon computer program codes executable by a processor for implementing a display method, the display method including dividing a display screen according to a golden ratio, displaying first content and second content on a first area and a second area of the display screen, respectively, and changing the display of the second content according to a time point at which the first content is displayed.

As described above, the display apparatus and method according to the various embodiments allow automatic partitioning a display screen according to the number of content items so as to minimize a page scroll according to the number of captured content items when the content is reproduced, thereby increasing user convenience.

### BRIEF DESCRIPTION OF THE DRAWINGS

The above and other features and advantages of the invention will become more apparent by describing in detail exemplary embodiments thereof with reference to the attached drawings in which:

FIG. 1 illustrates an exemplary structure of a digital photographing apparatus as an example of a display apparatus, according to an embodiment;

FIG. 2 illustrates the structure of a Central Processing Unit (CPU)/Digital Signal Processor (DSP), according to an embodiment;

FIGS. 3A through 3F illustrate a display screen partitioned into a plurality of areas, according to an embodiment;

FIGS. 4A through 4C are diagrams for explaining the operation of displaying moving and still images, according to an embodiment;

FIG. 5 illustrates a display screen partitioned into a plurality of areas, according to another embodiment;

FIG. 6 illustrates the structure of a CPU/DSP, according to another embodiment;

FIG. 7 is a diagram for explaining the operation of changing the position of a still image according to a time point at which a moving image is replayed;

FIGS. 8A through 8D are diagrams for explaining the operation of displaying moving and still images, according to another embodiment;

FIG. 9 is a flowchart of a display method, according to an embodiment; and

FIG. 10 is a flowchart of a display method, according to another embodiment.

### DETAILED DESCRIPTION

The following descriptions and the attached drawings are intended for understanding an operation according to embodiments of the invention. Parts of the operation that may be easily realized by those skilled in the art may be omitted. The specification and the drawings are not provided for limiting the invention, and a scope of the invention should be defined by the appended claims. The terminology used herein should be construed as having meanings and concepts consistent with the technical spirit of the invention, in order to most appropriately describe the invention. As used herein, the term “and/or” includes any and all combinations of one or more of the associated listed items.

Embodiments of the invention will now be described with reference to the attached drawings.

An image reproducing apparatus according to embodiments of the invention may be realized as various types of devices such as a digital photographing apparatus, a personal computer (PC), a laptop, and a mobile phone.

While the specification describes an embodiment of a digital photographing apparatus as an image reproducing apparatus, the scope of the invention should be defined by the appended claims and is not limited to the embodiment described herein.

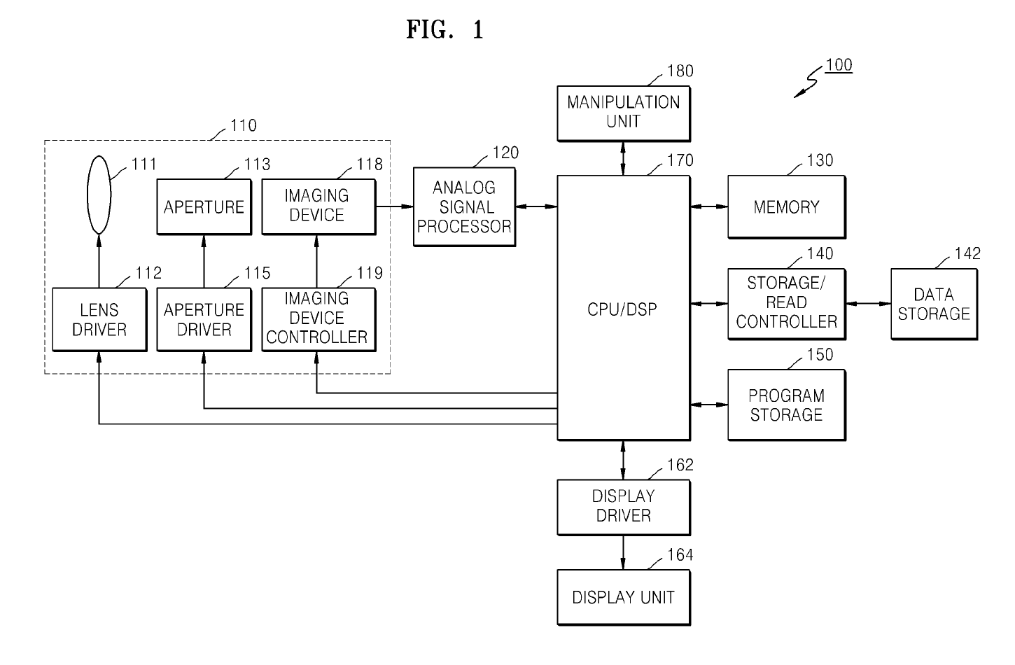

FIG. 1 is a block diagram of a digital photographing apparatus 100, according to an embodiment.

Referring to FIG. 1, the digital photographing apparatus 100 includes a photographing unit 110, an analog signal processor 120, a memory 130, a storage/read controller 140, a data storage 142, a program storage 150, a display driver 162, a display unit 164, a Central Processing Unit (CPU)/Digital Signal Processor (DSP) 170, and a manipulation unit 180.

The overall operation of the digital photographing apparatus 100 is controlled by the CPU/DSP 170. The CPU/DSP 170 provides a lens driver 112, an aperture driver 115, and an imaging device controller 119 with control signals for controlling operations of the lens driver 112, the aperture driver 115, and the imaging device controller 119.

The photographing unit 110 generates an image corresponding to an electric signal from incident light and includes a lens unit 111, the lens driver 112, an aperture 113, the aperture driver 115, an imaging device 118, and the image device controller 119.

The lens unit 111 may include a plurality of lens groups, each of which includes a plurality of lenses. The lens driver 112 adjusts the positions of the lenses of the lens groups of the lens unit 111 according to a control signal provided by the CPU/DSP 170. The aperture driver 115 adjusts the extent to which the aperture 113 opens or closes. The aperture 113 controls the amount of light incident onto the imaging device 118.

An optical signal that has passed through the lens unit 111 and the aperture 113 creates an image of a subject on a light-receiving surface of the imaging device 118. The imaging device 118 may be a charge-coupled device (CCD) image sensor or a complementary metal-oxide semiconductor image sensor (CIS) that converts an optical signal into an electric signal. The imaging device controller 119 may regulate the sensitivity and other factors of the imaging device 118. The imaging device controller 119 may control the imaging device 118 according to a control signal automatically generated by an image signal input in real time or a control signal manually input by user manipulation.

The exposure time of the imaging device 118 may be adjusted by a shutter (not shown). The shutter may be classified into a mechanical shutter that adjusts the amount of incident light by moving the position of a black screen and an electronic shutter that controls exposure by supplying an electric signal to the imaging device 118. The analog signal processor 120 performs noise reduction, gain control, waveform shaping, and analog-to-digital conversion on an analog signal provided by the imaging device 118.

A signal processed by the analog signal processor 120 may be input to the CPU/DSP 170 directly or through the memory 130. In this case, the memory 130 operates as a main memory of the digital photographing apparatus 100 and temporarily stores information necessary when the CPU/DSP 170 is operating. The program storage 150 stores programs such as an application system and an operating system for running the digital photographing apparatus 100. The display unit 164 displays an operating state of the digital photographing apparatus 100 or image information obtained by the digital photographing apparatus 100. The display unit 164 may provide visual information and/or audio information to a user. In order to provide visual information, the display unit 164 may include a liquid crystal display (LCD) panel or an organic light-emitting display (OLED) panel. The display unit 164 may also be a touch screen that can recognize a touch input. The display driver 162 supplies a driving signal to the display unit 164.

The CPU/DSP 170 processes an input image signal and controls each component of the digital photographing apparatus 100 according to the image signal or an external input signal. The CPU/DSP 170 may perform image signal processing on input image data, such as noise reduction, gamma correction, color filter array interpolation, color matrix, color correction, and color enhancement, in order to improve image quality. The CPU/DSP 170 also compresses the image data obtained by the image signal processing into an image file or reconstructs the original image data from the image file. An image compression algorithm may be reversible or irreversible. For example, a still image may be compressed into a Joint Photographic Experts Group (JPEG) format or a JPEG 2000 format. For recording of a moving image, a plurality of frames may be compressed into a moving image file according to Moving Picture Experts Group (MPEG) standards. For example, an image file may be created according to Exchangeable image file format (Exif).

Image data output from the CPU/DSP 170 may be fed into the storage/read controller 140 directly or through the memory 130. The storage/read controller 140 stores the image data in the data storage 142 automatically or according to a signal input from the user. The storage/read controller 140 may also read data related to an image from an image file stored in the data storage 142 and input the data to the display driver 162 through the memory 130 or another path so as to display the image on the display unit 164. The data storage 142 may be detachably or permanently attached to the digital photographing apparatus 100.

Furthermore, the CPU/DSP 170 may perform sharpness processing, chromatic processing, blur processing, edge emphasis, image interpretation, image recognition processing, image effect processing, and the like. The image recognition processing may include face recognition and scene recognition. The CPU/DSP 170 also processes a display image signal so as to display a corresponding image on the display unit 164. For example, the CPU/DSP 170 may perform luminance level adjustment, color correction, contrast adjustment, edge enhancement, screen segmentation, character image generation, and image synthesis. The CPU/DSP 170 may be connected to an external monitor and perform a predetermined image signal processing method so as to display the resulting image on the external monitor. The CPU/DSP 170 may then transmit the image data obtained by the predetermined image signal processing method to the external monitor so that the resulting image can be displayed on the external monitor.

The CPU/DSP 170 executes programs stored in the program storage 150 or includes a separate module to generate control signals for controlling auto focusing (A F), zoom change, focus change, and automatic exposure correction, to provide the control signals to the aperture driver 115, the lens unit driver 112, and the imaging device controller 119, and to control overall operations of components in the digital photographing apparatus 100 such as a shutter and a flash (strobe).

The manipulation unit 180 allows an input of control signals from a user. The manipulation unit 180 may include a shutter release button for inputting a shutter-release signal that is used to take photographs by exposing the imaging device 118 to incoming light for a predetermined time, a power button for inputting a control signal in order to control the power on/off state of the digital photographing apparatus 100, a zoom button for widening and narrowing an angle of view according to an input, and various other function buttons such as a mode selection button and other photographing set value adjustment buttons. The manipulation unit 180 may be realized in any form that allows a user to input a control signal, such as a button, a keyboard, a touch pad, a touch screen, or a remote controller.

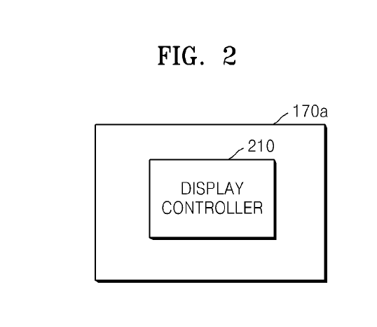

FIG. 2 illustrates the structure of a CPU/DSP 170a, according to an embodiment. Referring to FIG. 2, the CPU/DSP 170a includes a display controller 210.

The display controller 210 partitions a display screen into a plurality of areas according to a golden ratio and allows a first content and a second content to be displayed on first and second areas of the display screen, respectively.

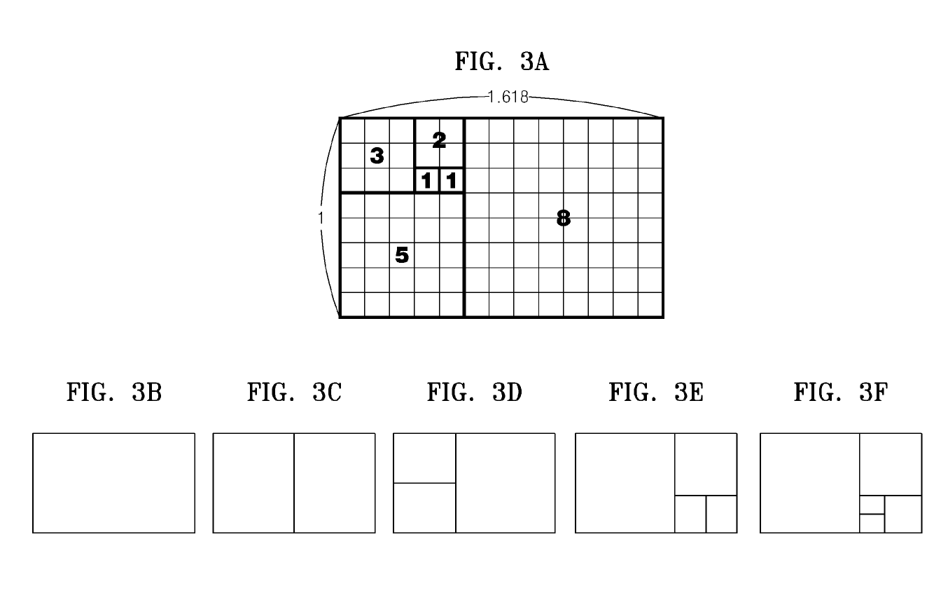

FIGS. 3A through 3F illustrate a display screen partitioned into a plurality of areas, according to an embodiment. More specifically, the display screen is divided into a plurality of areas according to a golden ratio derived from the Fibonacci sequence.

The Fibonacci sequence is defined by Equation (1):

$${M}_{i , k}^{l} = \{ \begin{matrix}0 & if n = 0 ; \\ 1 & if n = 1 ; \\ {F}_{n - 1} + {F}_{n - 2} & if n > 1.\end{matrix} \qquad ( 1 )$$

The Fibonacci sequence begins with 0 and 1 and each subsequent number in the sequence is the sum of the previous two numbers, so that Fibonacci numbers for n=0, 1, 2 . . . are 0, 1, 1, 2, 3, 5, 8, 13, 21 . . .

The most important property of the Fibonacci sequence is that the ratio between successive Fibonacci numbers approximates a golden ratio which is 0.618. For example, when n is from 3 through 6, the ratios of one number to the succeeding number in the sequence are 2:3 (0.667), 3:5 (0.6), and (5:8) 0.625, which approximate about 0.618 (the golden ratio). If a line a is divided according to the golden ratio, the ratio of a longer segment to the overall line a approximately equals to 0.618. Thus, the ratio of successive terms F(n):F(n+1) is 1:1.618 and is supposed to visually give a sense of balance and referred to as the golden ratio.

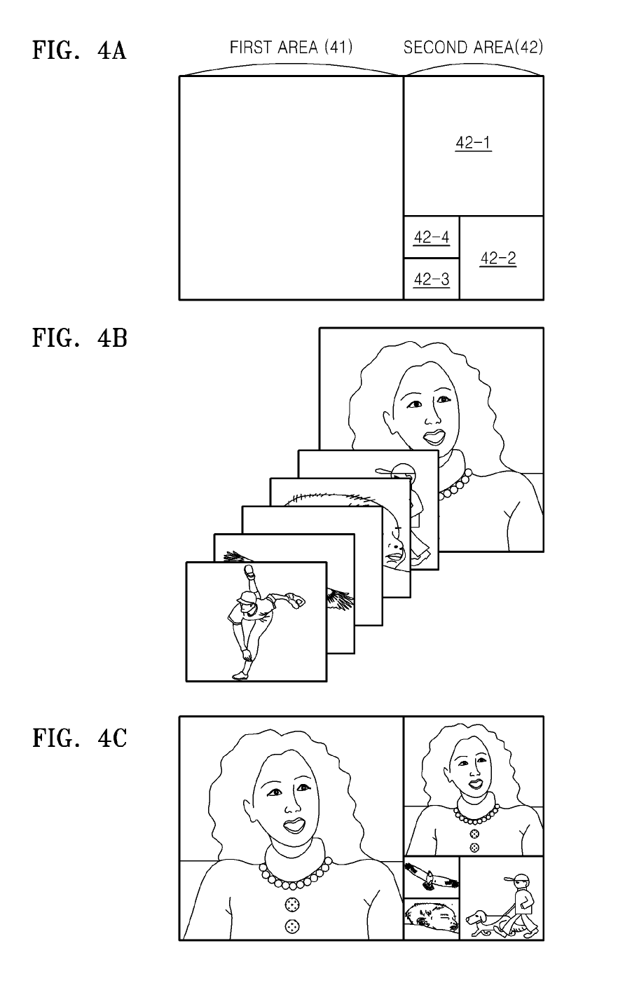

FIG. 3A illustrates a display screen divided into 6 areas in the golden ratio of 1:1.168, which is a width to height ratio. When the basic unit of a lattice is 1 unit, a number indicated in each area represents the number of units along the edge of the area. FIGS. 3B through 3F illustrate display screens partitioned in the golden ratio according to the desired number of areas. FIGS. 3B through 3F illustrate display screens having 1, 2, 3, 4, and 5 partition areas, respectively. While the present embodiment is described using the display screen partitioned into 5 areas in the golden ratio as shown in FIGS. 3F and 4A, the display screen may be partitioned into a different number of areas such as 3 or 6 areas.

Referring to FIG. 4A, the display controller 210 divides the whole display screen into first and second areas 41 and 42 at the golden ratio of 1:1.618. The display controller 210 further divides the second area 42 according to the golden ratio. For convenience of explanation, it is assumed that the second area 42 is subdivided into four regions 42-1 through 42-4 having the golden ratio.

The display controller 210 allows first content and second content to be displayed on the first area 41 and the second area 42, respectively. The second area 42 may be further divided according to the number of second content items based on the golden ratio.

In the present embodiment, moving image data is displayed on the first area 41 while still image data is being displayed on the second area 42. The moving image data and the still image data are correlated with each other and may be captured in a continuous shot mode, pre-recording mode, or dual shot mode.

For example, if 5 still images are captured while a moving image is being taken for a predetermined time, as shown in FIG. 4B, the display controller 210 allows the moving image to be displayed on the first area 41 while allowing four still images to be displayed on the first through fourth regions 42-1 through 42-4 of the second area 42, as shown in FIG. 4C.

In order to display the fifth captured still image on the second area 42 on which the four still images are displayed, as shown in FIG. 4C, the display controller 210 may update the first region 42-1 of the second area 42 with the fifth captured still image. For updating, the fifth captured still image may be displayed on any one of the first through fourth regions 42-1 through 42-4.

Alternatively, when the number of captured still images exceeds the number of partition regions in the second area, the display controller 210 may allow the first through fourth regions 42-1 through 42-4 to be displayed in the form of slides so that still images not shown on the first through fourth regions 42-1 through 42-4 can be displayed as slides. If four still images are captured for display, the first through fourth regions 42-1 through 42-4 may be sequentially repeatedly displayed in the form of slides. In this case, still images displayed in a small size on the third and fourth regions 42-3 and 42-4 may also be displayed on the second and third regions 42-2 and 42-3.

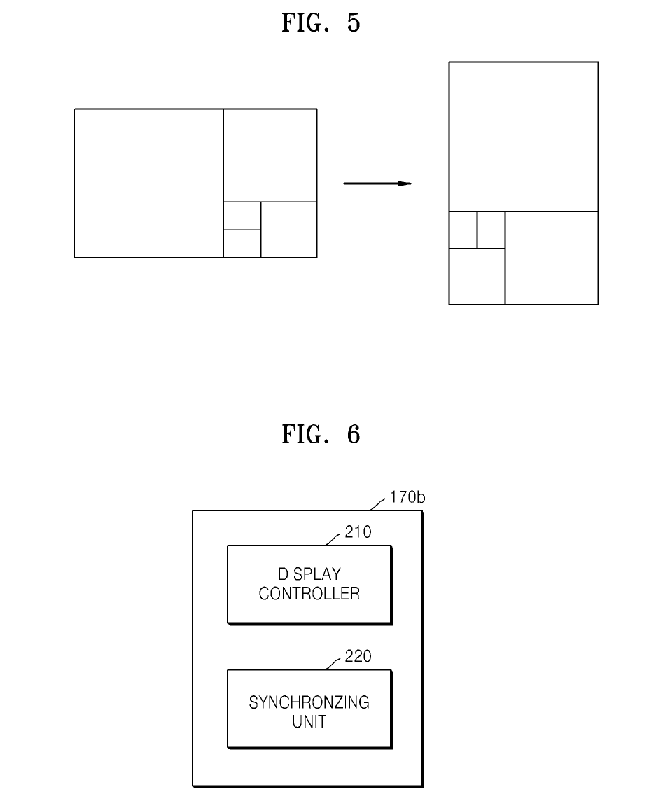

Referring to FIG. 5, the display controller 210 may also allow partitioning of a portrait mode display screen in which the width is less than the height according to the golden ratio. A user may selectively change the display screen from landscape to portrait mode or vice versa.

FIG. 6 illustrates the structure of a CPU/DSP 170b, according to another embodiment.

The CPU/DSP 170b includes a display controller 210 and a synchronizing unit 220.

The display controller 210 divides a display screen according to a golden ratio and allows a moving image as a first content and a still image as a second content to be displayed on first and second areas (41 and 42 in FIG. 4A) of the display screen, respectively. Hereinafter, since the display controller 210 has substantially the same function as in the previous embodiment described with reference to FIG. 2, a detailed description thereof is omitted.

The synchronizing unit 220 changes the position of a still image being displayed according to a time point at which the moving image is displayed.

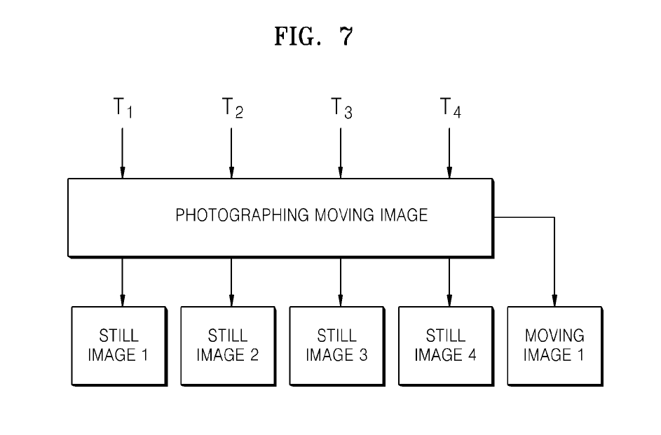

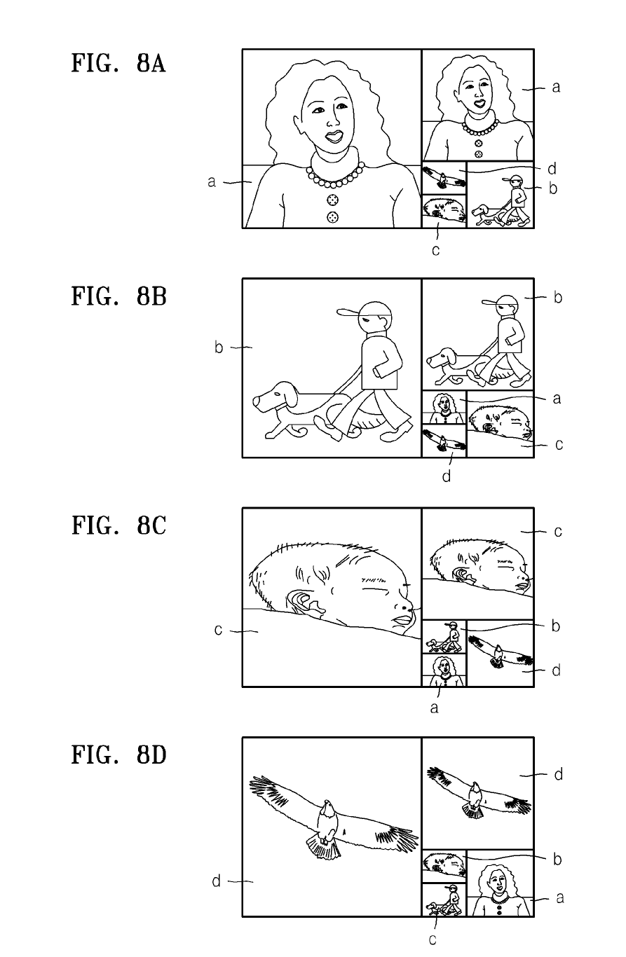

FIG. 7 is a diagram for explaining the operation of changing the position of a still image according to a time point at which a moving image is replayed. Referring to FIG. 7, during capturing of a moving image 1, still images 1 through 4 may be captured at time points T1 through T4, respectively.

Thereafter, the display controller 210 controls the display of the moving and still images in cooperation with the synchronizing unit 220. The display of the moving and still images will now be described with reference to FIGS. 8A through 8D.

The display controller 210 controls the display unit (164 in FIG. 1) to displays moving image 1 on the first area 41 and still images 1 through 4 on the first through fourth regions (42-1 through 42-4 in FIG. 4A) of the second area 42, respectively.

FIG. 8A shows that a still image a captured at a time point T1 that is closest to a time point where a moving image displayed on the first area 41 is captured. The still image a is displayed on the first region 42-1 while the remaining still images b through d captured at time points T2 through T4 are being displayed on the second through fourth regions 42-2 through 42-4, respectively.

Referring to FIG. 8B, after a lapse of a predetermined time, a still image b captured at the time point T2 that is closest to a time point where a moving image displayed on the first area 41 is captured is displayed on the first region 42-1 while the remaining still images c, d, and a captured at time points T3, T4, and T1 are being displayed on the second through fourth regions 42-2 through 42-4, respectively.

Referring to FIG. 8C, after a further lapse of a predetermined time, a still image c captured at the time point T3 that is closest to a time point where a moving image displayed on the first area 41 is captured is displayed on the first region 42-1 while the remaining still images d, a, and b captured at time points T4, T1, and T2 are being displayed on the second through fourth regions 42-2 through 42-4, respectively.

Referring to FIG. 8D, after a further lapse of a predetermined time, a still image d captured at the time point T4 that is closest to a time point where a moving image displayed on the first area 41 is captured is displayed on the first region 42-1 while the remaining still images a through c captured at time points T1 through T3 are being displayed on the second through fourth regions 42-2 through 42-4, respectively.

As described above, the display controller 210 and the synchronizing unit 220 are configured to display still images on the first region 42-1 of the second area 42 in sequential order from a still image captured at a time point that is closest to a time point where a moving image displayed on the first area 41 is captured. The operation of the display controller 210 and the synchronizing unit 220 allows a user to easily view a still image related to a moving image while the moving image is being replayed.

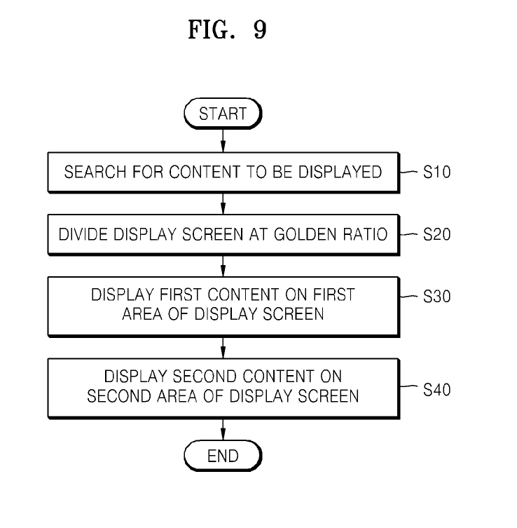

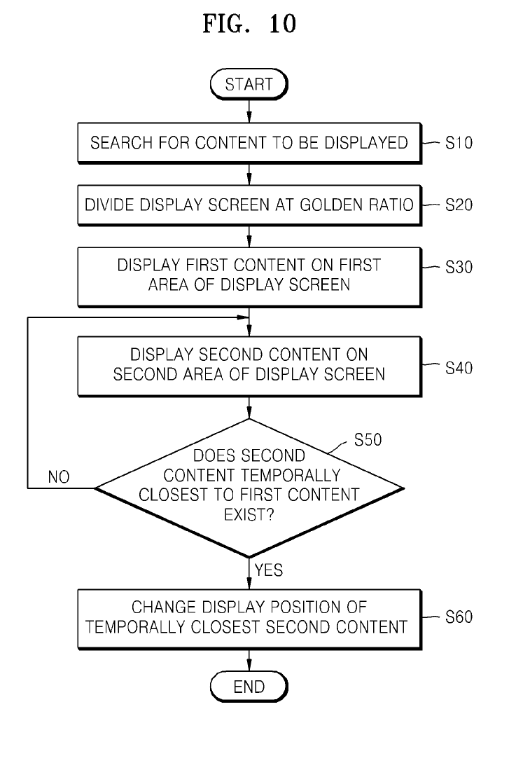

Display methods according to embodiments will now be described with reference to FIGS. 9 and 10. The display methods may be performed by the digital photographing apparatus 100 of FIG. 1. Depending on the application, a main algorithm of the display method may be implemented by the CPU/DSP 170 in cooperation with other components in the digital photographing apparatus 100.

FIG. 9 is a flowchart of a display method, according to an embodiment. Referring to FIG. 9, upon receiving a signal to reproduce content from a user, the CPU/DSP (170 in FIG. 1) searches the data storage (142 in FIG. 1) for a content to be displayed (S10). The content is classified into moving image data and still image data. The moving image data and the still image data may be first content and second content, respectively. The moving image data and the still image data also are correlated with each other and may be captured in a continuous shot mode, pre-recording mode, or dual shot mode. In the present embodiment, it is assumed that the moving image data and the still image data are captured in a dual shot mode.

Upon completing the search for the content to be displayed, the CPU/DSP 170 divides a display screen according to a golden ratio derived from the Fibonacci sequence (S20). More specifically, the CPU/DSP 170 partitions the display screen at a height to width ratio of 1:1.168 (golden ratio). For example, the display screen may be divided into first and second areas at the golden ratio, and the second area is further divided into first through fourth regions at the same golden ratio. In this case, the number of partition areas may be adjusted depending on settings.

After completing the division of the display screen at the golden ratio, the CPU/DSP 170 displays a moving image as the first content on a first area of the display screen (S30) and a still image as the second content on a second area of the display screen (S40). While FIG. 9 shows that the operations S30 and S40 are sequentially performed, they may be performed simultaneously or in reverse order.

When the number of still images exceeds the number of regions created by partitioning the second area at the golden ratio (e. g., 4), the CPU/DSP 170 may update the second area with a new still image not displayed before. The CPU/DSP 170 may also display the second area in the form of slides so that a captured still image not shown on the second area can be displayed as a slide.

A display method according to another embodiment will now be described with reference to FIG. 10. Repeated descriptions with respect to FIG. 9 are omitted to avoid redundancy.

Referring to FIG. 10, upon receiving a signal to reproduce content from a user, the CPU/DSP 170 searches the data storage 142 for a content to be displayed (S10).

Upon completing the search for the content to be displayed, the CPU/DSP 170 divides a display screen according to a golden ratio derived from the Fibonacci sequence (S20).

After completing partitioning of the display screen at the golden ratio, the CPU/DSP 170 displays a moving image as the first content on a first area of the display screen (S30) and a still image as the second content on a second area of the display screen (S40). While FIG. 10 shows that operations S30 and S40 are sequentially performed, they may be performed simultaneously or in reverse order.

The CPU/DSP 170 determines whether a still image temporally closest to a displayed moving image exists (S50).

If the still image temporally closest to the displayed moving image exists, the CPU/DSP 170 changes the position of a still image being displayed so that the temporally closest still image can be displayed on the largest region of the second area (S60). Since the CPU/DSP 170 performs this operation in the same manner as described with reference to FIG. 8, a detailed description thereof is omitted.

The invention may be embodied as a computer-readable code on a computer-readable storage medium. The computer-readable storage medium is any data storage device that can store data which can be thereafter read by a computer system.

Examples of computer-readable storage media include read-only memory (ROM), random-access memory (RAM), CD-ROMs, magnetic tapes, floppy disks, optical data storage devices, etc. The computer-readable storage media can also be distributed over network-coupled computer systems so that computer-readable codes are stored and executed in a distributed fashion. Furthermore, functional programs, codes, and code segments for accomplishing embodiments of the invention can be easily programmed by programmers skilled in the art to which the invention pertains.

While the invention has been particularly shown in the drawings and described with reference to specific components and exemplary embodiments thereof, it will be understood by those of ordinary skill in the art that various changes in form and details may be made therein without departing from the spirit and scope of the invention as defined by the following claims. Therefore, it should be understood that the exemplary embodiments described therein should be considered in a descriptive sense only and not for purposes of limitation. The scope of the invention is defined not by the detailed description of the invention but by the appended claims, and all differences within the scope of the appended claims and their equivalents will be construed as being included in the invention.

All references, including publications, patent applications, and patents, cited herein are hereby incorporated by reference to the same extent as if each reference were individually and specifically indicated to be incorporated by reference and were set forth in its entirety herein.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention. No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. It should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A display apparatus comprising:
a display controller that allows first content and second content to be displayed on a first area and a second area of a display screen, respectively,
wherein the display controller divides the first and second areas according to a golden ratio.

2. The apparatus of claim 1, wherein the display controller partitions the second area according to the number of second content items according to the golden ratio.

3. The apparatus of claim 2, wherein the second content is displayed in the form of slides.

4. The apparatus of claim 1, wherein the display controller adjusts the number of partitions in the second area.

5. The apparatus of claim 4, wherein when the number of the second content items exceeds a predetermined number, the display controller updates the second area with the second content other than the predetermined number of the second content items for display.

6. The apparatus of claim 1, wherein the display controller divides the first and second areas according to the golden ratio derived from the Fibonacci sequence.

7. The apparatus of claim 1, wherein the first content is moving image data, and the second content is still image data.

8. The apparatus of claim 7, wherein the still image data constitutes the moving image data.

9. A display apparatus comprising:
a display controller that allows first content and second content to be displayed on a first area and a second area of a display screen, respectively; and
a synchronizing unit that changes the display of the second content according to a time point at which the first content is displayed,
wherein the display controller divides the first and second areas of the display screen according to a golden ratio.

10. The apparatus of claim 9, wherein the display controller partitions the second area according to the number of the second content items according to the golden ratio.

11. The apparatus of claim 10, wherein the second content is displayed in the form of slides.

12. The apparatus of claim 9, wherein the display controller adjusts the number of partitions in the second area.

13. The apparatus of claim 12, wherein when the number of the second content items exceeds a predetermined number, the display controller updates the second area with the second content other than the predetermined number of the second content for display.

14. The apparatus of claim 9, wherein the display controller divides the first and second areas at the golden ratio derived from the Fibonacci sequence.

15. The apparatus of claim 9, wherein the first content is moving image data, and the second content is still image data.

16. The apparatus of claim 15, wherein the still image data constitutes the moving image data.

17. A display method comprising:
dividing a display screen according to a golden ratio and displaying first content and second content on a first area and a second area of the display screen, respectively.

18. A display method comprising:
dividing a display screen according to a golden ratio;
displaying first content and second content on a first area and a second area of the display screen, respectively; and
changing the display of the second content according to a time point at which the first content is displayed.

19. A non-transitory computer-readable storage medium having stored thereon computer program codes executable by a processor for implementing a display method, the display method comprising dividing a display screen according to a golden ratio and displaying first content and second content on a first area and a second area of the display screen.

20. A non-transitory computer-readable storage medium having stored thereon computer program codes executable by a processor for implementing a display method, the display method comprising:
dividing a display screen according to a golden ratio;
displaying first content and second content on a first area and a second area of the display screen, respectively; and
changing the display of the second content according to a time point at which the first content is displayed.
